(19) United States
(12) Patent Application Publication
(10) Pub. No.: US 2025/0377528 A1
(43) Pub. Date: Dec. 11, 2025

(54) Microscope and Microscopy Method

(71) Applicant: Carl Zeiss Microscopy GmbH, Jena (DE)

(72) Inventors: Richard Hollinger, Jena (DE); Ralf Netz, Jena (DE); Joerg Siebenmorgen, Jena (DE); Lars Loetgering, Jena (DE)

(21) Appl. No.: 19/230,830

(22) Filed: Jun. 6, 2025

(30) Foreign Application Priority Data
Jun. 7, 2024 (DE) 10 2024 116 029.2

(51) Int. Cl. G02B 21/06; G02B 21/24

(52) U.S. Cl. CPC G02B 21/06; G02B 21/241

(57) ABSTRACT

A microscope for examining a sample comprising a light source for providing illumination light for illuminating a sample, an illumination beam path comprising a microscope objective for guiding the illumination light onto the sample, a detector for detecting emission light emitted by the sample, a detection beam path comprising a microscope objective for guiding the emission light onto the detector, and a control unit for controlling the light source and for evaluating measurement data from the detector. The illumination beam path has a beam shaping unit for providing a coherent flat-top region and an adjustable optical functional group, wherein, depending on the setting state of the adjustable optical functional group, at least one coherent flat-top region is situated in the region of a pupil plane or at least one coherent flat-top region is situated in the region of an intermediate image plane. A method of microscopy for examining a sample is described.

The current application claims the benefit of German Patent Application No. 10 2024 116 029.2, filed on 7 Jun. 2024, which is hereby incorporated by reference.

In a first aspect, the invention relates to a microscope for examining a sample according to the preamble of claim 1. In a second aspect, the invention relates to a method of microscopy for examining a sample according to the preamble of claim 23.

A generic microscope has at least the following component parts: a light source for providing illumination light for illuminating a sample, an illumination beam path comprising a microscope objective for guiding the illumination light onto the sample, a detector for detecting emission light emitted by the sample owing to irradiation with the illumination light, a detection beam path comprising the microscope objective or comprising a further microscope objective for guiding the emission light onto the detector, and a control unit for controlling the light source and for evaluating measurement data from the detector.

In a generic method of microscopy, at least the following method steps are carried out: illumination light is guided onto the sample via an illumination beam path comprising a microscope objective, emission light emitted by the sample owing to irradiation with the illumination light is guided onto a detector via a detection beam path comprising the microscope objective or comprising a further microscope objective, and measurement data of the detector are evaluated by a control unit.

Generic microscopes and generic methods are known in many configurations and variants, for example from DE 10 2022 103 051 A1.

For many microscopy techniques, the illumination of a region in a sample plane or of a region in a pupil plane with the most homogeneous, i.e. uniform, intensity distribution possible is desired. Such illumination modes are also referred to as flat-top illuminations.

In addition, coherent illumination is often desired, especially when SLMs (spatial light modulators) are used to condition the illumination light.

In the past, numerous techniques have been developed for transforming Gaussian laser beam profiles into coherent flat-top beam profiles, with three main approaches existing for achieving homogeneous and coherent illumination.

In a first, comparatively easy to realize possibility, the laser beam with the Gaussian beam profile is trimmed with a stop, for example a mechanical structural part or a coated optical unit, in such a way that in the end only a near-axis region of the beam is used, in which the intensity distribution is substantially homogeneous. In one variant, a diffractive element can be used to cut out the desired beam components from the Gaussian beam to be shaped. With a wedge-shaped phase of the diffractive element, the desired components of the Gaussian beam can then be spatially separated from the undesired components [Salter]. By spatially adapting the wedge-shaped phase pattern to the Gaussian beam to be shaped, the homogenization can be increased [Nakata]. One disadvantage of these methods is that the light blocked by the stop and the light components removed with the aid of the diffractive element are lost and are no longer available for use.

A further possibility for achieving flat-top illumination is to redistribute the intensity distribution of a Gaussian beam through an optical unit in such a way that the desired beam profile is created at the output of this optical unit. Shaping the intensity profile of a laser beam by way of redistributing the light power is possible both with refractive optical units, in particular using aspherical lenses, but also with diffractive components such as DOEs (DOE=diffractive optical element) or SLMs. Diffractive optical units may be either of transmissive design, e.g. comprising transmissive SLMs and/or transmissive DOEs, or of reflective design, e.g. comprising LCOS SLMs (LCOS=Liquid Crystal on Silicon) and/or comprising reflective DOEs [Midel Photonics]. DOEs have the disadvantage that they are optimized for a specific wavelength, and hence are monochromatic.

A phase function that must be used to control a DOE or an SLM in order that a Gaussian beam is converted into a beam having the desired homogeneous intensity profile can be determined using the Gerchberg-Saxton algorithm. However, this algorithm has the disadvantage that the phase after beam shaping is not flat, but rather chaotic. The correction of the phase can be carried out with the aid of a second phase modulator in an optically conjugate plane [Jesacher]. In the case of the Gerchberg-Saxton algorithm, an iterative method is used to calculate a phase pattern which generates a desired illumination pattern in the intermediate image when it is represented with given illumination on a spatial light modulator in an upstream pupil plane. Intermediate image and pupil are linked with one another by way of a Fourier transformation in a fundamentally known manner. In principle, any desired patterns, including three-dimensional patterns, can be generated, although the algorithm requires a substantial computational complexity [Ger72].

Further algorithms have been proposed for approaches that serve to reduce “speckles”, hence spot-like deviations of the beam profile from homogeneity, in holograms [Schmidt]. However, this is accompanied by a reduced luminous efficiency when the algorithm exhibits relatively high complexity.

Finally, under the keywords “generalized phase contrast”, a method is known in which a phase pattern of the image to be imaged is generated in an intermediate image plane [Glückstad]. A common-path interferometer is then generated, in which a rectangular or round phase mask (phase contrast filter) with a phase deviation of pi for the low spatial frequencies is installed in a pupil plane. The intensity profile of the image to be imaged can then be recovered from interference of the phase-shifted low spatial frequencies and non-modulated higher spatial frequencies.

In this case, the spatial coherence relates to a flat phase of the shaped beam after beam shaping. As described above, beam shaping by trimming the spatial beam profile is generally not expedient owing to high power losses.

Beam shaping units based on beam redistribution with the aid of refractive optical units are commercially available from the companies ADL-Optics, Berlin (product: πShaper; [http://pishaper.com/shaper.html) and Asphericon, Jena (product: a TopShape; https://www.asphericon.com/produkte/beamtuning/strahlformung).

It is furthermore known to realize refractive or diffractive optical units with the aid of 3D printing methods and/or using nanostructures and/or metamaterials directly on a fibre end of a single-mode fibre. In addition to the component parts that bring about the actual beam shaping, it is also possible, by means of 3D printing methods, to print spherical and aspherical optical units that serve for collimating the shaped beam.

When generating a flat-top beam from a Gaussian beam using a refractive beam shaping unit or redistributor, with an appropriate choice of optical units, it is possible for the optical set-up to be realized in achromatic fashion in the visible (VIS) spectral range as well [US2004264007A1, U.S. Pat. No. 6,487,022B1]. With this kind of beam shaping, it is considered to be disadvantageous that, in contrast to a Gaussian beam, the flat-top beam shape is not propagation-invariant.

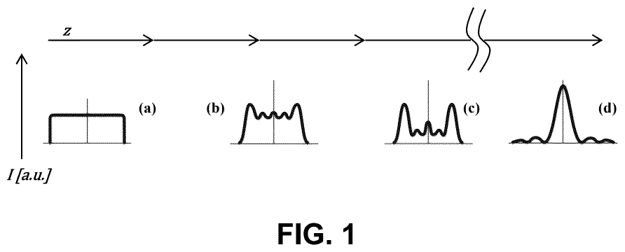

These facts will be described with reference to FIG. 1 [Laskin Laskin], which illustrates the development of the intensity profile of the laser beam at four different axial locations along the propagation of said beam in free space. Whereas a flat-top distribution is present in the case of the situation shown in FIG. 1a, this profile changes in the course of the propagation of the laser beam in the propagation direction over the distributions in FIGS. 1b) and 1c) until ultimately in the far field in FIG. 1d) a beam distribution is present which has the shape of an Airy function, hence the Fourier transform of a flat-top profile.

The axial range downstream of the beam shaping unit in which the desired flat-top distribution is present and diffraction-induced beam transformations of the kind illustrated in FIG. 1 can be disregarded is 1.5 m in the case of commercially available monochromatic beam shaping units. However, this value decreases to a few centimetres for beam shaping units that are achromatic in the visible (VIS) radiation range. No values are available as yet in this respect for the optical units printed using 3D printing methods.

In order to be able to use the achromatic behaviour of a refractive beam shaping unit, a region of the illumination beam path in which a flat-top distribution is present has to be imaged into a region or a plane of the illumination beam path in which the flat-top illumination is intended to be applied. This can be done, for example, as described in [Laskin Laskin], using 4f telescope imaging. [Laskin] described the use of flat-top illumination for generating computer-generated holograms using LCOS and DMD SLMs.

It has been found that it is not possible to attain flat-top illumination in the sample plane or in an intermediate image plane if a phase modulation in a pupil plane is not carried out beforehand in the illumination beam path. This results in substantial limitations with regard to the availability of flat-top illumination for different microscopy methods.

An object of the invention can be considered that of specifying a microscope and a method of microscopy in which flat-top illuminations are usable for different microscopy methods.

This object is achieved by the microscope having the features of claim 1 and by the method of microscopy having the features of claim 23.

Advantageous exemplary embodiments of the microscope according to the invention and preferred variants of the method according to the invention are explained below, in particular in association with the dependent claims and the figures.

According to the invention, the microscope of the type specified above is developed further in that the illumination beam path has a beam shaping unit for providing a coherent flat-top region and an adjustable optical functional group, wherein, depending on the setting state of the adjustable optical functional group, at least one coherent flat-top region is situated in the region of a pupil plane or at least one coherent flat-top region is situated in the region of an intermediate image plane.

According to the invention, the method of the type mentioned above is developed further in that the illumination beam path has a beam shaping unit for providing a coherent flat-top region and an adjustable optical functional group, and in that the optical functional group, for the purpose of conditioning the illumination beam path for a respectively desired microscopy mode, either is brought to a setting state in which at least one flat-top region is situated in the region of a pupil plane, or is brought to a setting state in which at least one flat-top region is situated in the region of an intermediate image plane.

As a light source for the microscope according to the invention, owing to the requirement of coherence, in essence lasers are conceivable, but other light sources are also possible. The illumination light, which can also be referred to as excitation light, is electromagnetic radiation preferably in the visible range and adjacent ranges. With regard to the samples to be examined, there is no restriction, in principle. The samples to be examined will often be biological samples.

The term illumination beam path denotes all optical beam-guiding and beam-modifying components, for example a microscope objective, lenses, mirrors, prisms, gratings, filters, stops, beam splitters, modulators, for example spatial light modulators (SLM), by means of which and via which the excitation light from the light source is guided to the sample to be examined. Beam-modifying components also encompass dispersive and in particular diffractive elements. Commercially available microscope objectives can be used, in principle.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

The emission light is electromagnetic radiation emitted by the sample illuminated with the excitation light. Emitting means that the detection light comes from the sample. The emission light can also be referred to as detection light. The emission light can be reflected back from the sample or can be light which is transmitted through the illuminated sample. The emission light can typically be, in comparison with the excitation light, red-shifted fluorescent light from fluorescent markers used to prepare the sample.

Commercially available detectors can be used as detectors. Particularly preferably, semiconductor detectors are used. The detector can be in particular a two-dimensionally spatially resolving detector, thus a camera, for example a CCD, CMOS or SPAD array camera. However, for specific microscopy techniques, for example those in which an illumination point or an illumination line is scanned over or through the sample, it is possible to use a punctiform detector, for example a photomultiplier, or a linear detector, for example a CCD or CMOS line array or a linear SPAD array.

The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy and for reflected-light microscopy in which the sample is illuminated and observed obliquely, as in light sheet microscopy, for example.

In the illumination beam path, for the purpose of varying those locations on or in the sample which are intended to be irradiated with the excitation light, a scanner can be present, for example having galvanometric mirrors or MEMS mirrors which are operated in a quasi-static or resonant fashion. Particularly preferably, the scanner mirrors are arranged in a pupil plane or in the vicinity of a pupil plane of the illumination beam path. However, a scanner is not absolutely necessary for the realization of the invention.

The term control unit denotes all hardware and software components which interact with the components of the microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The controller can have in particular customary operating devices and peripherals, such as mouse, keyboard, screen, storage media, joystick, Internet connection. The controller can in particular read the image data from the detector and can also be configured and serve to control the light source. According to the invention, the controller is at least configured to control the first spatial light modulator. If further spatial light modulators are present, the control unit can expediently also be configured for controlling these further light modulators.

A coherent flat-top region should be understood to mean a region having finite axial and finite lateral extent in the illumination beam path in which the illumination light has a substantially homogeneous and coherent light distribution.

An essential concept of the present invention can be considered that of installing in the illumination beam path an adjustable optical arrangement, namely the adjustable optical functional group, which makes it possible to change a location of a flat-top region and/or an optical character of a plane in which a flat-top region is situated.

For the purposes of this application, the term adjustable optical functional group denotes an arrangement of optical components, i.e. beam-guiding and/or beam-modifying components, such as for example lenses, mirrors, prisms, gratings, filters, stops, beam splitters, spatial light modulators, at least one component of which can be modified in terms of its optical properties and/or in terms of its spatial arrangement in such a way that the change—intended according to the invention—of a location of a flat-top region and/or of an optical character of a plane in which a flat-top region is situated is achieved.

The optical functional group can also include components which are already present in generic microscopes, for example lenses.

An essential advantage of the present invention can be considered that of extending the possible uses of flat-top illuminations for different microscopic methods. In particular, multimodal microscopes that can be used to carry out many different microscopic methods can be provided using the present invention.

In the case of the invention, in principle, any type of the various beam shaping units described above can be used for generating the coherent flat-top region. In one advantageous variant, the beam shaping unit has refractive and/or diffractive optical units for beam redistribution or is formed by such optical units. The beam shaping unit can also be referred to as a beam shaping module or as a flat-top shaper.

In order to realize the invention, it is sufficient if the beam shaping unit is monochromatic, i.e. can generate a coherent flat-top region only for a specific wavelength. It is particularly preferred, however, if the beam shaping unit is achromatic, particularly in the range of visible light. Applications of the invention are then possible for many different wavelengths of the illumination light.

Furthermore, the beam shaping unit can have a structured optical fibre or can be formed by a structured optical fibre. In this case, a refractive beam shaper can be integrally formed at a fibre end of the optical fibre, in particular by means of a 3D printing method. Supplementarily, a collimation lens can be integrally formed at the fibre end of the optical fibre, in particular by means of a 3D printing method.

Further preferred exemplary embodiments of the microscope according to the invention are distinguished by the fact that adjustable component parts of the optical functional group are controllable, and that the control unit is configured for controlling the adjustable component parts of the optical functional group. A location of a flat-top region in the illumination beam and/or an optical character of that plane in which a flat-top region is situated can thus be set or switched by way of the control unit in a convenient manner, for example by means of suitable interaction between a user and the control unit.

In principle, it is sufficient for the realization of the invention if the optical functional group can be used to set and thus define whether the flat-top region formed by the beam shaping unit lies in the region of a pupil plane or in the region of an intermediate image plane. One exemplary embodiment of such a realization will be described further below. However, it is also possible for the optical functional unit to be configured for reproducing the flat-top region and for variably axially displacing a flat-top region.

In one preferred exemplary embodiment, the optical functional group has a zoom optical unit comprising at least one axially movable lens. In different settings of the zoom optical unit, a flat-top region can then be positioned either in the region of a pupil plane or in the region of an intermediate image plane. For the purpose of setting the axially movable lens or if appropriate a plurality of axially movable lenses, actuators that are controllable by the control unit can expediently be present.

In a further group of preferred configurations of the microscope according to the invention, the optical functional group has at least one spatial light modulator or the optical functional group is formed by a spatial light modulator.

By way of example, the control unit can be configured to control the spatial light modulator for realizing a lens, the focal length of which is equal to the distance between the spatial light modulator and the closest downstream intermediate image plane.

The spatial light modulator can be referred to as the first spatial light modulator and can be, in principle, the sole spatial light modulator in the illumination beam path. However, it is also possible for a second spatial light modulator to be arranged in the illumination beam path, which is situated in or in the vicinity of a pupil plane when the first spatial light modulator is situated in or in the vicinity of an intermediate image plane, and which is situated in or in the vicinity of an intermediate image plane when the first spatial light modulator is situated in or in the vicinity of a pupil plane.

The first spatial light modulator and/or if appropriate the second and/or further spatial light modulators can additionally serve for realizing different illumination modes for different microscopy methods.

By way of example, at least one first spatial light modulator can be present, which is arranged in a pupil plane or in the vicinity of a pupil plane or in an intermediate image plane or in the vicinity of an intermediate image plane, and the control unit can advantageously be configured to control the first spatial light modulator for the purpose of conditioning the illumination light for a respectively desired microscopy method.

In principle, it is possible for at least one, a plurality or each of the components of first spatial light modulator, second spatial light modulator, spatial light modulator, to be formed by an amplitude-modulating spatial light modulator. It is advantageous, however, if at least one, a plurality or each of the components of first spatial light modulator, second spatial light modulator, spatial light modulator, is or are formed by a phase-modulating spatial light modulator. Phase-modulating spatial light modulators are preferred in general owing to the smaller light losses.

Then at least one, a plurality or each of the components of first spatial light modulator, second spatial light modulator, spatial light modulator, can be formed by a reflective spatial light modulator. However, it is also possible for at least one, a plurality or each of the components of first spatial light modulator, second spatial light modulator, spatial light modulator, to be formed by a transmissive spatial light modulator.

By way of example, at least one, a plurality or each of the components of first spatial light modulator, second spatial light modulator, spatial light modulator, can be formed by one or more of the following components: DMD (Digital Mirror Device), nematic SLM, LCOS display (LCOS=Liquid Crystal on Silicon), variable phase plate, adjustable lens, adaptive lens, controllable deformable mirror (DM).

In a further preferred exemplary embodiment, the optical functional group has a changer device comprising a first lens and a second lens or it is realized by a changer device comprising a first lens and a second lens. Alternatively or, where possible, supplementarily, provision can also be made for the optical functional group to have a lens with an adjustable focal length or to be realized by a lens with an adjustable focal length.

By way of example, the optical functional group can have an adjustable lens group comprising a lens with an adjustable focal length and a lens with a fixed focal length or can be realized by an adjustable lens group comprising a lens with an adjustable focal length and a lens with a fixed focal length.

In order to provide a pupil plane and/or an intermediate image plane in the illumination beam path, a telescope optical unit can additionally be present.

In a further preferred configuration, the optical functional group has an optical module forming an alternative beam path comprising at least one lens, said alternative beam path having a pupil plane and an intermediate image plane, wherein the illumination light either in the first setting state or in the second setting state is guided via the alternative beam path in the direction of the microscope objective. This exemplary embodiment makes it possible to realize a variant in which different setting states of the optical functional group are substantially distinguished by the fact that, depending on the setting of the optical functional group, an intermediate image plane or a pupil plane lies in that region in which the flat-top region generated by the beam shaping unit is provided.

The optical module can, for example, have a first switching device, in particular an adjustable first mirror, for the purpose of guiding the illumination light via the alternative beam path of the illumination beam path, and can have a second switching device, in particular an adjustable second mirror, for the purpose of coupling the excitation light from the alternative beam path once again into a main part of the illumination beam path. It is also possible for the first mirror and the second mirror to be jointly insertable into the illumination beam path and removable therefrom, and for further component parts of the optical module and/or of the optical functional group to remain invariable upon the switching of the optical functional group.

In one preferred variant, the optically effective component parts of the optical module are rigidly connected to one another upon the insertion of the optical module into the illumination beam path and upon the removal of the optical module from the illumination beam path. Specifically, that can mean that the optical functional group is adjustable into the first setting state by introduction of the optical module into the illumination beam path and is adjustable into the second setting state by removal of the optical module from the illumination beam path. An actuator that is controllable by the control unit can expediently be present for the purpose of introducing the optical module into the illumination beam path and for the purpose of removing the optical module from the illumination beam path.

For the purpose of compensating for quadratic phase components, the illumination beam path can expediently comprise a wavefront manipulator, in particular a field lens, which is arranged or formed in an intermediate image plane or in the vicinity of an intermediate image plane. The field lens can be formed by a lens with an adjustable focal length, for example. Alternatively, the wavefront manipulator can have a lens of a lens changer comprising a plurality of lenses of varying focal length. Finally, it is also possible for the field lens to be formed by a suitably controllable spatial light modulator in the intermediate image plane.

In one particularly preferred configuration of the microscope according to the invention, for TIRF microscopy, an optical unit for generating a lateral beam offset for laterally displacing TIRF illumination spots in the back focal plane of the microscope objective is present in a pupil plane of the illumination beam path and/or a pivotable mirror for laterally displacing TIRF illumination spots in the back focal plane of the microscope objective is present in an intermediate image plane of the illumination beam path.

Alternatively or, where possible, supplementarily, for SIM microscopy, a biaxially pivotable wobble plate can be present or two, in each case uniaxially pivotable wobble plates can be present in the vicinity of an intermediate image plane of the illumination beam path.

The control unit can then preferably be configured to control the spatial light modulator in the pupil plane for the purpose of generating a computer-generated hologram for illuminating the sample.

One advantageous variant of the method according to the invention then consists in that the optical functional group is set in such a way that a flat-top region is situated in the region of an intermediate image plane, and in that a spatial light modulator arranged in the intermediate image plane is controlled for carrying out SIM or TIRF microscopy, or in that the sample is examined by means of a widefield microscope method.

In a further variant of the method according to the invention, the optical functional group is set in such a way that a flat-top region is situated in the region of a pupil plane, and a spatial light modulator arranged in the pupil plane is controlled for generating a computer-generated hologram.

Advantageously, regions of the sample illuminated by the computer-generated hologram can then examined by means of a widefield microscopy method.

Further advantages and features of the invention are explained below with reference to the accompanying figures, in which:

FIG. 1: shows schematic graphic diagrams for elucidating the properties of a coherent flat-top profile;

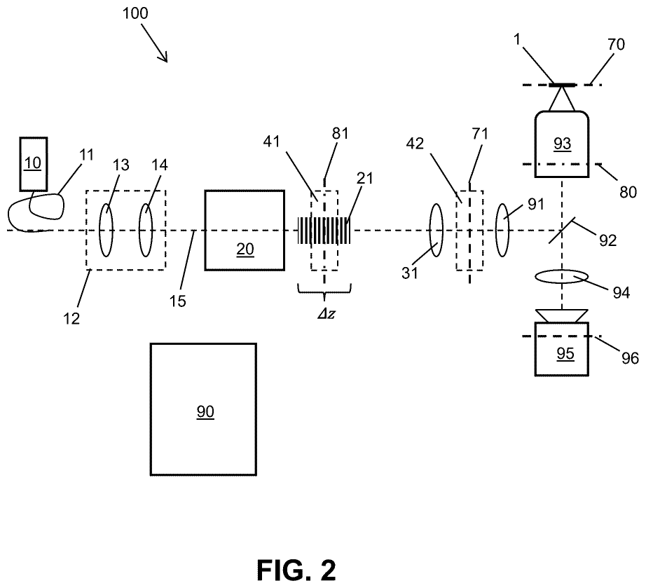

FIG. 2: shows one microscope that does not belong to the invention;

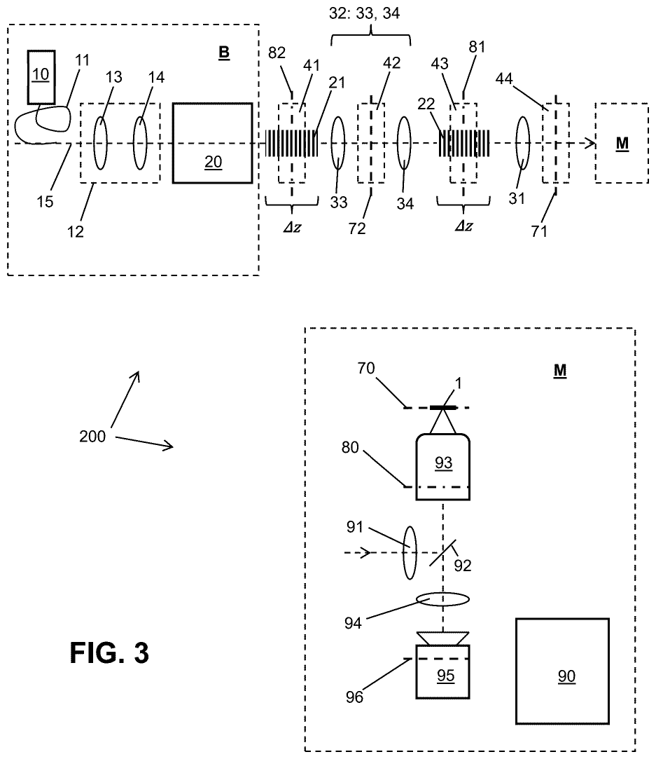

FIG. 3: shows a further microscope that does not belong to the invention;

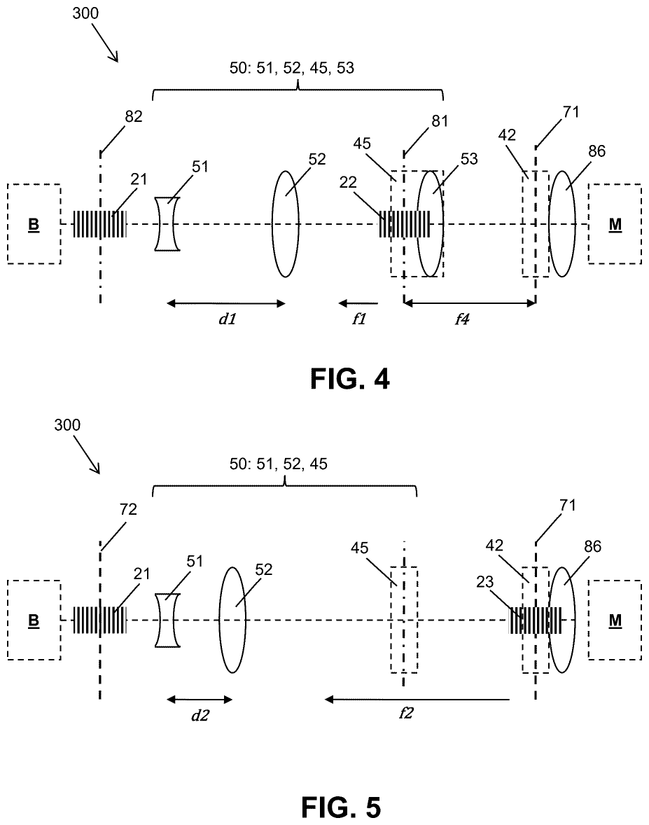

FIG. 4: shows a first exemplary embodiment of a microscope according to the invention, in which the optical functional group is in a first setting state;

FIG. 5: shows the microscope from FIG. 4, in which the optical functional group is in a second setting state;

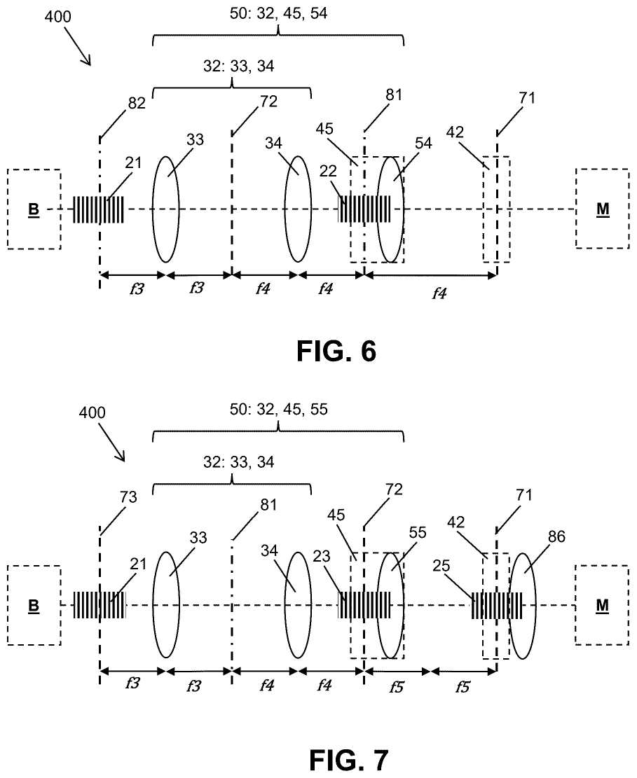

FIG. 6: shows a second exemplary embodiment of a microscope according to the invention, in which the optical functional group is in a first setting state;

FIG. 7: shows the microscope from FIG. 6, in which the optical functional group is in a second setting state;

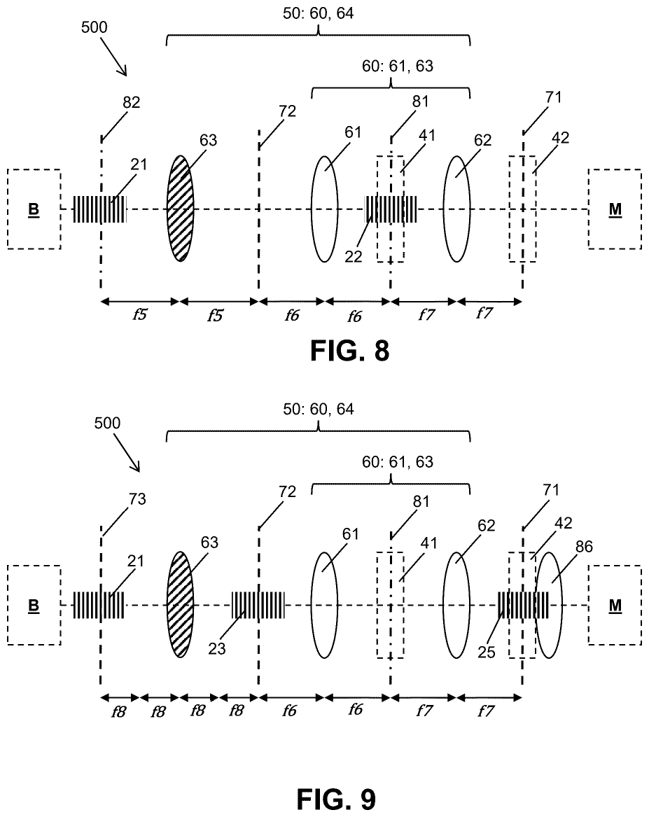

FIG. 8: shows a third exemplary embodiment of a microscope according to the invention, in which the optical functional group is in a first setting state;

FIG. 9: shows the microscope from FIG. 8, in which the optical functional group is in a second setting state;

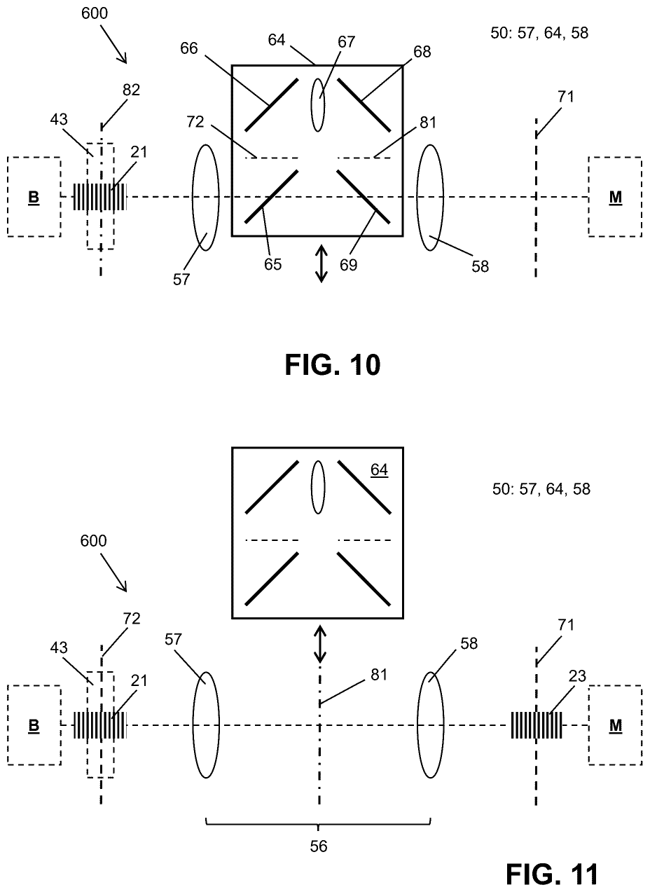

FIG. 10: shows a fourth exemplary embodiment of a microscope according to the invention, in which the optical functional group is in a first setting state;

FIG. 11: shows the microscope from FIG. 10, in which the optical functional group is in a second setting state;

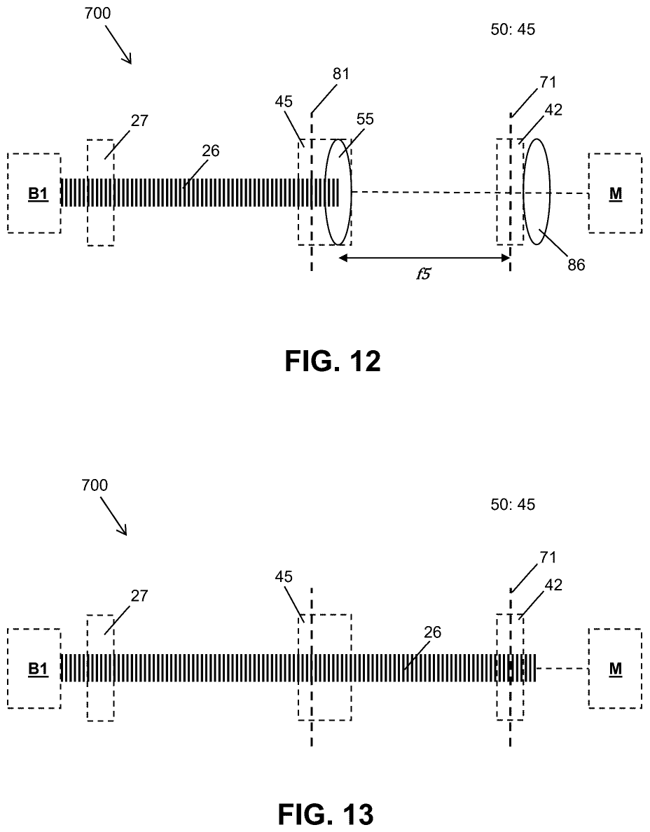

FIG. 12: shows a fifth exemplary embodiment of a microscope according to the invention, in which the optical functional group is in a first setting state;

FIG. 13: shows the microscope from FIG. 12, in which the optical functional group is in a second setting state;

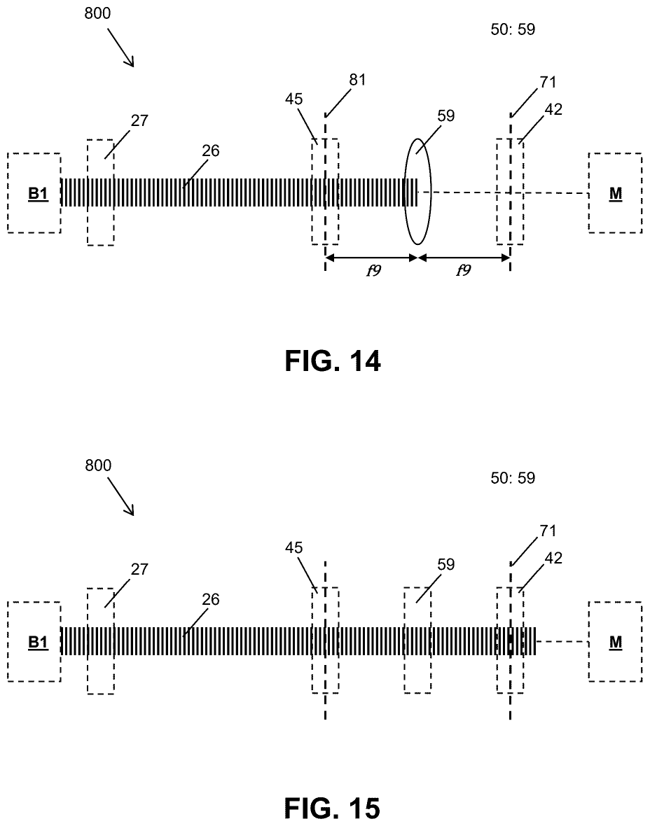

FIG. 14: shows a sixth exemplary embodiment of a microscope according to the invention, in which the optical functional group is in a first setting state, and

FIG. 15: shows the microscope from FIG. 14, in which the optical functional group is in a second setting state.

Identical and identically acting components are generally provided with the same reference signs in the figures.

In each of FIGS. 2 to 11, a first intermediate image plane in the illumination beam path is provided with the reference sign 71 and further intermediate image planes in the illumination beam path, as viewed in the direction of the light source proceeding from the first intermediate image plane 71, bear the reference signs 72, 73. Likewise, in each of FIGS. 2 to 11, a first plane that is optically conjugate to a back focal plane of a microscope objective in the illumination beam path, i.e. a first pupil plane, is provided with the reference sign 81 and a further pupil plane in the illumination beam path in the direction of the light source bears the reference sign 82.

Firstly, the stated object of the present invention will be explained with reference to FIGS. 2 and 3, which each show microscopes that do not belong to the invention.

The microscope 100 shown in FIG. 1 firstly has: a light source 10 for providing illumination light for illuminating a sample 1, an illumination beam path comprising a microscope objective 93 for guiding the illumination light onto the sample 1, a detector 95 for detecting emission light emitted by the sample 1 owing to irradiation with the illumination light, a detection beam path comprising the microscope objective 93 for guiding the emission light onto the detector 95, and a control unit 90 for controlling the light source 10 and for evaluating measurement data from the detector 95. The control unit 90 can also serve for controlling further components of the microscope 100, in particular spatial light modulators. The controller 90 is operatively connected to the components which it serves to control and whose measurement data it evaluates, the connection being effected by cables, for example, which are not illustrated in the figures. The light source 10 can typically be a laser. The detector 95 can be a camera, for example.

As a further important component part, the illumination beam path has a beam shaping unit 20, which provides a coherent flat-top region 21. The illumination beam path then specifically has the following components. Firstly, the illumination light supplied by the light source 10 passes via an optical fibre 11 and a collimation optical unit 12 comprising lenses 13, 14 into the beam shaping unit 20, which provides the coherent flat-top region 21 as intended. Free-space incoupling of the illumination light supplied by the light source 10 into the beam shaping unit 20, i.e. without the optical fibre 11, is also possible, however. The collimation optical unit can have an adjustable telescope optical unit, for example, which can be used to set a beam diameter, and the collimation optical unit can also be formed by such a telescope optical unit. The flat-top region 21 extends over a region Δz in the direction of an optical axis 15 and additionally has a finite extent in each of the two lateral spatial directions x, y perpendicular to the optical axis 15, which are not identified by their own reference signs in FIG. 2. The illumination light then passes via a lens 31, a tube lens 91 of the illumination beam path and a main beam splitter 92 into the microscope objective 93 and is guided by the latter as intended into a sample plane 70, in which the sample 1 is arranged.

The coherent flat-top region 21 lies in a pupil plane 81 generated by a 4f imaging of the back focal plane 80 of the microscope objective 93, said 4f imaging being realized by the lens 31 and the tube lens 91. In the pupil plane 81, a spatial light modulator 41, for example a phase modulator, can be situated, and can be used to generate computer-generated holograms in the sample plane 70, for example for the targeted illumination of specific regions of interest (ROIs) in the sample.

Moreover, in the first intermediate image plane 71 lying between the lens 31 and the tube lens 91, a spatial light modulator 42 can be present, and can be used for example for the purposes of structured illumination microscopy. It should be noted that with the arrangement in FIG. 2 it is not possible to transfer the flat-top region into the intermediate image plane 71 without carrying out a phase modulation in the pupil plane 81.

Emission light emitted by the sample 1 owing to irradiation with the illumination light is reflected back from the sample 1 in the direction of the microscope objective 93 and is then guided by the latter in the direction of the main beam splitter 92, passes through the latter and is then imaged via a tube lens 94 in the detection beam path into an intermediate image plane 96 of the detector 95.

The main beam splitter 92 can typically be a dichroic colour splitter that reflects the illumination light, but transmits fluorescent light from the sample 1 that is red-shifted in comparison with the illumination light.

For the case where, in the set-up in FIG. 2, an arrangement of a spatial light modulator 41 in the pupil plane 81 is not possible or is unfavourable, for instance for installation space reasons, the pupil plane 81 in which the spatial light modulator 41 is intended to be arranged can be generated using an additional telescope optical unit in the illumination beam path at a location remote from the beam shaping unit 20. This will be explained on the basis of the microscope 200 in FIG. 3.

In comparison with the microscope 100 in FIG. 2, the microscope 200 in FIG. 3 has an extension in the form of the telescope optical unit 32 provided by the lenses 33 and 34. The components of the microscope 200 including the tube lens 91 and downstream thereof do not differ from the corresponding component parts of the microscope 100 from FIG. 2 and are combined in a microscope detection module designated by “M” in FIG. 3. The components of the microscope 200 including the beam shaping unit 20 and upstream thereof as far as the light source 10 do not differ from the corresponding component parts of the microscope 100 from FIG. 2 and are combined in an illumination module designated by “B” in FIG. 3.

In FIG. 3, the flat-top region 21 provided by the beam shaping unit 20 is situated in the region of a second pupil plane 82 afforded by a 4f imaging of the first pupil plane 81, said 4f imaging being afforded by the lenses 33 and 34. As in FIG. 2, the pupil plane 81 is generated by a 4f imaging of the back focal plane 80 of the microscope objective 93, said 4f imaging being realized by the lens 31 and the tube lens 91. That means that both in the pupil plane 81 and, if allowed by the installation space, in the pupil plane 82, the light of the flat-top regions 21, 22 can be manipulated by spatial light modulators 41, 43, for example in order to generate computer-generated holograms in the sample plane 70.

Moreover, in FIG. 3, a spatial light modulator 44 can be arranged in the intermediate image plane 71 and a spatial light modulator 42 can be arranged in a further intermediate image plane 72 formed between the lenses 33 and 34 of the telescope optical unit 32. The spatial light modulators 42, 44 can each be phase modulators and can be used for example for the purposes of structured illumination microscopy and/or for TIRF microscopy.

What is important, however, is that the set-up in FIG. 3 also does not make it possible to use flat-top illumination in one of the intermediate image planes 71, 72 without carrying out a phase modulation in one of the pupil planes 81, 82.

In the microscopes 100, 200 in FIGS. 2 and 3, the spatial light modulator has to be arranged in each case in one of the pupil planes 81, 82. The beam shaping unit 20 can be positioned in each case such that a pupil plane 81, 82 is situated within the region in which a good quality of the flat-top region 21 is present. FIGS. 2 and 3 show, however, that it is not possible to attain flat-top illumination in the sample plane or one of the intermediate image planes 71, 72 if no phase modulation takes place in a pupil plane upstream thereof, for example the pupil plane 81 in FIG. 2 or the pupil planes 81, 82 in FIG. 3. An object of the invention, then, can be considered that of circumventing this limitation and providing extended possibilities of application for the flat-top region 21 generated by the beam shaping unit 20.

The exemplary embodiments of the microscope according to the invention are each distinguished by the fact that, according to the invention, the illumination beam path has a beam shaping unit 20 for providing a coherent flat-top region 21 and additionally an adjustable optical functional group 50, wherein, depending on the setting state of the adjustable optical functional group 50, at least one coherent flat-top region 21, 22 is situated in the region of a pupil plane 81, 82 or at least one coherent flat-top region 23 is situated in the region of an intermediate image plane 71, 72, 73.

Exemplary embodiments of the microscope according to the invention and for the adjustable optical functional group 50 will be explained below in association with FIGS. 4 to 11.

A first exemplary embodiment for a microscope 300 according to the invention comprising an optical functional group 50 will be explained in association with FIGS. 4 and 5. In the case of the microscope 300 according to the invention, the optical functional group 50 has a zoom optical unit comprising a lens element 51 arranged in stationary fashion in the illumination beam path and an axially displaceable lens 52. A further variable component part of the optical functional group 50 is constituted by a spatial light modulator 45 and a lens 53 realized, if appropriate, by the latter.

In the situation illustrated in FIG. 4, the axially displaceable lens 52 is situated at a distance d1 from the lens 51 arranged in stationary fashion. The zoom optical unit set in this way realizes a focal length f1 in such a way that the flat-top region 21 is imaged onto a flat-top region 22. Moreover, the spatial light modulator 45, which can be a phase modulator, for example, is controlled in such a way that the function of a lens 53 with a focal length f4 is realized. The focal length f4 is equal to the distance from the plane in which the spatial light modulator 45 is arranged as far as the closest intermediate image plane in the beam direction, i.e. as far as the first intermediate image plane 71. The effect of the lens 53 causes the plane in which the spatial light modulator 45 is situated to become a first pupil plane, which is identified by the reference sign 81 in FIG. 4. That means that, in FIG. 4, the flat-top region 22 lies in the first pupil plane 81 and the flat-top region 21 lies in the second pupil plane 82. The flat-top illumination in the first pupil plane 81 and the spatial light modulator 45 arranged there can then be used, as described above, for generating computer-generated holograms in the sample 1.

In the case of the situation shown in FIG. 5, the axially displaceable lens 52 is situated at a distance d2 relative to the lens 51 arranged in stationary fashion, such that a focal length f2 is realized by the zoom optical unit. In this case, the spatial light modulator 45 is set to neutral and the flat-top region 21 is imaged onto the flat-top region 23 in the first intermediate image plane 71 by the zoom optical unit 51, 52. That means that, in FIG. 5, the flat-top region 23 lies in the first intermediate image plane 71 and the flat-top region 21 lies in the second intermediate image plane 72. The flat-top illumination in the first intermediate image plane 71 and the spatial light modulator 42 arranged there can then be made usable, as described above, for structured illumination microscopy (SIM) or for TIRF microscopy (TIRF=total internal reflection fluorescence).

In FIG. 5, the plane in which the spatial light modulator 45 is situated is neither an intermediate image plane nor a pupil plane.

In one variant, the effect of the lens 53 could also be realized in full or in part by pivoting a lens with a suitable focal length into the illumination beam path.

The lens 86 serves to compensate for quadratic phase terms that arise on account of the deviation of the optical imagings in the illumination beam path from pure 4f imagings, in order therefore, in other words, to guarantee a flat wavefront and in order to avoid adverse effects in the following beam path.

A second exemplary embodiment of a microscope 400 according to the invention will be explained with reference to FIGS. 6 and 7. In this example, the optical functional group 50 is provided by a telescope optical unit 32 comprising lenses 33 and 34, and a spatial light modulator 45, which is controlled for the purpose of realizing lenses with different focal lengths.

In the situation shown in FIG. 6, the spatial light modulator 45, for example a phase modulator, is controlled for the purpose of realizing a lens 54 with a focal length f4 corresponding to the distance between the spatial light modulator 45 and the intermediate image plane 71. In FIG. 6, therefore, the effect of the lens 54 causes the plane in which the spatial light modulator 45 is situated to become the first pupil plane 81. The telescope optical unit 32 comprising the lenses 33, 34 images the first pupil plane 81 into that plane in which the flat-top region 21 is situated, i.e. this plane becomes the second pupil plane 82. The flat-top region 21 in the second pupil plane 82 is thus imaged into the flat-top region 22 in the first pupil plane 81 by way of a 4f imaging by the telescope optical unit 32. The flat-top illumination in the first pupil plane 81 and the spatial light modulator 45 arranged there can then be used, as described above, for generating computer-generated holograms in the sample 1.

In the case of the situation shown in FIG. 7, the spatial light modulator 45 is controlled for the purpose of realizing a lens 55 with a focal length f5 corresponding to half the distance between the spatial light modulator 45 and the first intermediate image plane 71. The effect of the lens 55 then causes the plane in which the spatial light modulator 45 is situated to become the second intermediate image plane 72. With the 4f imaging mediated by the telescope optical unit 32, the plane in which the flat-top region 21 is situated then becomes the third intermediate image plane 73. The telescope optical unit 32 thus images the flat-top region 21 into the flat-top region 23 in the second intermediate image plane 72 by way of a 4f imaging. The flat-top illumination in the second intermediate image plane 72 and the spatial light modulator 45 arranged there can then be made usable, as described above, for structured illumination microscopy or for TIRF microscopy.

For the correction of a quadratic phase, once again a field lens 86 arranged in the region of the intermediate image plane 71 can be present or a phase modulator 42 arranged in the intermediate image plane can be controlled for the purpose of fully or partly realizing such a lens 86.

As in the exemplary embodiment in FIGS. 4 and 5, it is also possible, instead of the control of the spatial light modulator 45 to form different lenses 54 and 55, to pivot different lenses with the corresponding focal lengths into the illumination beam path, for example by means of a lens changer. Finally, it is also possible for the effects of the lenses 54, 55 required for the functionality of the optical functional group 50 as described here to be provided in each case only in part by suitable control of the wavefront modulator 45 and in part by real lenses to be pivoted into the beam path and/or by an adjustable lens. The relay 32 comprising the lenses 33 and 34 is not absolutely necessary in the exemplary embodiment in FIGS. 6 and 7.

In the third exemplary embodiment of a microscope 500 according to the invention as shown in FIGS. 8 and 9, the optical functional group 50 is provided by an adjustable lens 63 and a telescope optical unit 60 comprising lenses 61, 62, by which the first intermediate image plane 71 is in each case imaged into the second intermediate image plane 72. Situated between the lenses 61 and 62 is a first pupil plane 81, in which a spatial light modulator 41 can be arranged. A further spatial light modulator 42 can be arranged in the first intermediate image plane 71.

In the case of the situation shown in FIG. 8, the adjustable lens 63 is set to a focal length f5, such that the adjustable lens 63 and the lens 61 mediate a 4f imaging between the pupil plane 81 and that plane in which the flat-top region 21 is situated. The flat-top region 21 thus lies in the second pupil plane 82 and is imaged onto the flat-top region 22 in the first pupil plane 81. The flat-top illumination in the first pupil plane 81 and the spatial light modulator 41 arranged there can then be used, as described above, for generating computer-generated holograms in the sample 1.

In the case of the situation illustrated in FIG. 9, the adjustable lens 63 is set to a focal length f8. That has the effect that the second intermediate image plane 72 is imaged into that plane in which the flat-top region 21 is situated. This plane thus becomes the third intermediate image plane 73. The flat-top region 21 is correspondingly imaged into the flat-top region 23 in the second intermediate image plane 72 and then via the telescope optical unit 60 into the flat-top region 25 in the first intermediate image plane 71.

The flat-top illumination in the first intermediate image plane 71 and the spatial light modulator 42 arranged there can then be made usable, as described above, for structured illumination microscopy or for TIRF microscopy. Alternatively or supplementarily, a spatial light modulator could also be arranged in the second intermediate image plane 72 and the flat-top illumination present there could be used with this spatial light modulator (not illustrated in FIG. 9) for instance for the purposes of structured illumination microscopy or for TIRF microscopy.

As in the exemplary embodiments described above, for the correction of quadratic phase terms that arise on account of the deviations from 4f imagings in FIG. 9, a field lens 86 can be provided, which for example can be pivoted into the beam path and/or can be realized in full or in part by suitable control of the spatial light modulator 42 in the first intermediate image plane 71 and/or in full or in part by an adjustable lens.

In the fourth exemplary embodiment of a microscope 600 according to the invention as illustrated in FIGS. 10 and 11, the optical functional group 50 is realized by an optical module 64 and lenses 57, 58.

In the first setting state illustrated in FIG. 10, the optical module 64 is situated in the illumination beam path. FIG. 11 shows the second setting state, in which the optical module 64 is withdrawn from the illumination beam path. The movement of the optical module 64 can be realized by an actuator that is controllable by way of the control unit 90 (not illustrated in the Figures).

The optical module 64 has a first mirror 65, a second mirror 66, a lens 67, a third mirror 68 and a fourth mirror 69. When the optical module 64, as shown in FIG. 10, as intended is situated in the illumination beam path, a first pupil plane 81 is formed between the third mirror 68 and the fourth mirror 69 and a second intermediate image plane 72 is formed between the first mirror 65 and the second mirror 66.

When the optical module 64, as shown in FIG. 11, as intended is not part of the illumination beam path, the first pupil plane 81 is situated between the lenses 57 and 58.

When the optical module 64, as shown in FIG. 10, as intended is situated in the illumination beam path, the illumination light passes via the first mirror 65, the second intermediate image plane 72, the second mirror 66, the lens 67, the third mirror 68 and the first pupil plane 81 to the fourth mirror 69 and is guided by the latter once again into the main part of the illumination beam path.

In FIG. 10, the back focal plane 80 of the microscope objective 93 is imaged by a 4f imaging into the first pupil plane 81, said 4f imaging being mediated by the tube lens 91 (back focal plane 80 of microscope objective 93 and tube lens 91 in microscope detection module M, see FIG. 3) and the lens 58. Via the lenses 67 and 57, the first pupil plane 81 is then imaged into the second pupil plane 82 by way of a 4f imaging. In FIG. 10, the flat-top region 21 therefore lies in the second pupil plane 82. The flat-top illumination in the second pupil plane 82 and the spatial light modulator 43 arranged there can then be used, as described above, for generating computer-generated holograms in the sample 1.

In FIG. 11, the lenses 57 and 58 form a telescope that images the first intermediate image plane 71 into that plane in which the flat-top region 21 is situated by way of a 4f imaging. In FIG. 11, the flat-top region 21 therefore lies in the second intermediate image plane 72. The flat-top illumination in the second intermediate image plane 72 and the spatial light modulator 43 arranged there can then be made usable, as described above, for structured illumination microscopy (SIM) or for TIRF microscopy. Alternatively or supplementarily, a spatial light modulator could also be arranged in the first intermediate image plane 71 and the flat-top illumination 23 present there could be used with this spatial light modulator (not illustrated in FIG. 9) for instance for the purposes of structured illumination microscopy or for TIRF microscopy.

In association with FIGS. 12 to 15, a fifth exemplary embodiment 700 and a sixth exemplary embodiment 800 of a microscope according to the invention will be explained, in which a modified illumination module B1 is present instead of the illumination module B. The modified illumination module B1 differs from the illumination module B in that the beam shaping unit 20 (not shown in FIGS. 12 to 15) is able to supply a coherent flat-top region 26 having a particularly large axial length. This is also referred to as a coherent flat-top region 26 having a particularly large propagation depth.

Firstly, the fifth exemplary embodiment 700 of a microscope according to the invention will be explained with reference to FIGS. 12 and 13. The adjustable optical functional group 50 present according to the invention is formed here by a spatial light modulator 45, for example a phase-modulating SLM. In the first setting state illustrated in FIG. 12, the spatial light modulator 45 is controlled by the control unit in order to produce a lens 55 with a focal length f5. The focal length f5 corresponds to the distance between the spatial light modulator 45 and the first intermediate image plane 71. The effect of the lens 55 causes the plane in which the spatial light modulator 45 is situated to become the first pupil plane 81. The propagation depth of a coherent flat-top region 26 supplied by the modified illumination module B1, i.e. the axial extent of said region, is of sufficient magnitude that the coherent flat-top region 26 extends as far as the spatial light modulator 45. In the situation shown in FIG. 12, therefore, in the pupil plane 81, the light of the coherent flat-top region 26 is available for further manipulation by the spatial light modulator 45. Quadratic phase terms generated by the lens 55 can optionally be corrected in the region of the intermediate image plane 71 with a field lens 86. By way of example, a spatial light modulator 42 present there can be controlled in order to produce this field lens 86. Alternatively, the lens 86 could also be pivoted into the beam path.

The second setting state of the microscope 700 according to the invention is illustrated in FIG. 13. In the situation shown there, the spatial light modulator 45 is situated in a neutral position. Consequently, the coherent flat-top region 26 is substantially not influenced by the spatial light modulator 45 and extends, as illustrated, as far as the first intermediate image plane 71. In the intermediate image plane 71, therefore, the light of the coherent flat-top region 26 is available for further manipulation by the spatial light modulator 42.

The reference sign 27 identifies a beam diverting device optionally present, for example comprising one mirror or a plurality of mirrors, which device can serve to guide the flat-top region 26 to a desired location.

The sixth exemplary embodiment 800 of a microscope according to the invention will be described with reference to FIGS. 14 and 15. Only the differences in comparison with the fifth exemplary embodiment 700 from FIGS. 12 and 13 will be explained here.

In the exemplary embodiment in FIGS. 14 and 15, the adjustable optical functional group 50 present according to the invention is realized by a lens 59 with an adjustable focal length. In the first setting state illustrated in FIG. 14, the adjustable lens 59 is controlled by the control unit in order to realize a lens with a focal length f9. The focal length f9 corresponds to the distance between the adjustable lens 59 and, on one side, the first intermediate image plane 71 and, on the other side, the plane in which the spatial light modulator 45 is situated. The effect of the adjustable lens 59 causes the plane in which the spatial light modulator 45 is situated to become the first pupil plane 81. In the situation in FIG. 14, therefore, in the pupil plane 81, the light of the coherent flat-top region 26 is available for manipulation by the spatial light modulator 45.

The second setting state of the microscope 800 according to the invention is illustrated in FIG. 15. In the situation shown there, the spatial light modulator 45 and the adjustable lens 59 are situated in a neutral position. Consequently, the coherent flat-top region 26 is substantially not influenced by the spatial light modulator 45 and the adjustable lens 59 and extends, as illustrated, as far as the first intermediate image plane 71. In the intermediate image plane 71, therefore, the light of the coherent flat-top region 26 is available for further manipulation by the spatial light modulator 42. Alternatively or supplementarily, a displaceable lens and/or a lens changer could also be used instead of or in addition to the adjustable lens 59.

The present invention describes a microscope comprising a novel illumination beam path which makes it possible firstly to generate high-quality computer-generated holograms in a sample, for example, and secondly to realize flat-top widefield illuminations and/or illuminations for SIM and TIRF methods with high quality.

### LIST OF REFERENCE SIGNS

1 sample
10 light source
11 optical fibre
12 collimation optical unit
13 first lens of collimation optical unit 12
14 second lens of collimation optical unit 12
15 optical axis
20 beam shaping unit, beam shaping module, flat-top shaper
21 coherent flat-top region supplied by beam shaping unit 20
22 coherent flat-top region in pupil plane
23 coherent flat-top region in intermediate image plane
25 coherent flat-top region in intermediate image plane
26 coherent flat-top region with large propagation depth
27 beam diverting device, for example one or a plurality of mirrors
31 lens in illumination beam path
32 telescope optical unit
33 first lens of telescope optical unit 32
34 second lens of telescope optical unit 32
41 spatial light modulator, phase manipulator in pupil plane
42 spatial light modulator, phase manipulator in intermediate image plane
43 spatial light modulator, phase manipulator in pupil plane or in intermediate image plane
44 spatial light modulator in intermediate image plane
45 spatial light modulator, phase manipulator in pupil plane or in non-distinguished plane
50 adjustable optical functional group
51 first lens of zoom optical unit, arranged in stationary fashion
52 second lens of zoom optical unit, arranged in axially displaceable fashion
53 lens with focal length f4 generated by spatial light modulator 45
54 lens with focal length f4 generated by spatial light modulator 45
55 lens with focal length f5 generated by spatial light modulator 45
56 telescope optical unit
57 first lens of telescope optical unit 56
58 second lens of telescope optical unit 56
59 lens with adjustable focal length or lens of lens changer
60 telescope optical unit
61 first lens of telescope optical unit 60
62 second lens of telescope optical unit 62
63 adjustable lens or lens of lens changer
64 optical module
65 first mirror of optical module 64
66 second mirror of optical module 64
67 lens in optical module 64
68 third mirror of optical module 64
69 fourth mirror of optical module 64
70 focal plane of microscope objective 93, sample plane, object plane
71 first intermediate image plane
72 second intermediate image plane
73 third intermediate image plane
80 back focal plane of microscope objective 93, pupil plane
81 first pupil plane
82 second pupil plane
86 field lens, optional; realized in full or in part by adjustable lens and/or in full or in part by lens of lens changer comprising a plurality of lenses of varying focal length and/or in full or in part by a lens generated by a spatial light modulator
90 control unit
91 tube lens in illumination beam path
92 main beam splitter
93 microscope objective
94 tube lens in the detection beam path
95 detector, camera
96 intermediate image plane in the detection beam path, in the camera 95
100 microscope, not belonging to the invention
200 microscope, not belonging to the invention
300 microscope according to the invention, first exemplary embodiment
400 microscope according to the invention, second exemplary embodiment
500 microscope according to the invention, third exemplary embodiment
600 microscope according to the invention, fourth exemplary embodiment
700 microscope according to the invention, fifth exemplary embodiment
800 microscope according to the invention, sixth exemplary embodiment
d1 distance between lens 51 and lens 52
d2 distance between lens 51 and lens 52
f1 focal length of zoom optical unit
f2 focal length of zoom optical unit
f3 focal length of lens 33
f4 focal length of lens 34 and of lens 54
f5 focal length of lens 55 and of lens 63
f6 focal length of lens 61
f7 focal length of lens 62
f8 focal length of lens 63
f9 focal length of lens 59
B illumination module
B1 modified illumination module
M microscope detection module
Δz axial extent of flat-top region 21, 22

### REFERENCES

[Nakata] Yoshiki Nakata, Kazuhito Osawa, Noriaki Miyanaga, Utilization of the high spatial frequency component in adaptive beam shaping by using a virtual diagonal phase grating. Scientific Reports 9:4640 (2019)

[Jesacher] A. Jesacher, et al., Near-perfect hologram reconstruction with a spatial light modulator. OPTICS EXPRESS 2597, 16, 4 (2008)

[Schmidt] S. Schmidt, et al., Tailored micro-optical freeform holograms for integrated complex beam shaping. Optica 1279, 7, 10 (2020)

[Midel Photonics] https://midel-photonics.de/#

[Printoptix] https://www.printoptix.com/

[Plidschun] Malte Plidschun et al., Fiber-based 3D nano-printed holography with individually phase-engineered remote points. Scientific Reports 12:20920 (2022)

[Stehr] Florian Stehr, et al., Flat-top TIRF illumination boosts DNA-PAINT imaging and quantification. Nature Communications 10:1268 (2019)

[Khaw] Ian Khaw, et al., Flat-field illumination for quantitative fluorescence imaging. Optics Express 26, 12 (2018)

[Glückstad] Andrew Bañas and Jesper Glückstad; Light Shaping with Holography, GPC and Holo-GPC. Opt. Data Process. Storage 3:20-40 (2017)

[Power] R. M. Power, et al., Automated 3D multi-color single-molecule localization microscopy. bioRxiv

[Laskin Laskin] A. Laskin, et al., Applying field mapping refractive beam shapers to improve holographic techniques. Proc. SPIE 8281, Practical Holography XXVI: Materials and Applications, 82810K (2012)

[Laskin] Alexander Laskin, Vadim Laskin, “Imaging techniques with refractive beam shaping optics,” Proc. SPIE 8490, Laser Beam Shaping XIII, 84900J (2012)

[Ger72] “A Practical Algorithm for the Determination of Phase from Image and Diffraction Plane Pictures”, Optik Vol. 35, No. 2 (1972)

1. Microscope for examining a sample, the microscope comprising:
a light source for providing illumination light for illuminating a sample,
an illumination beam path comprising a microscope objective for guiding the illumination light onto the sample,
a detector for detecting emission light emitted by the sample owing to irradiation with the illumination light,
a detection beam path comprising the microscope objective or
a further microscope objective for guiding the emission light onto the detector, and
a control unit for controlling the light source and for evaluating measurement data from the detector,
wherein the illumination beam path has a beam shaping unit for providing at least one coherent flat-top region and an adjustable optical functional group, wherein, depending on a setting state of the adjustable optical functional group, the at least one coherent flat-top region is situated in a region of a pupil plane or the at least one coherent flat-top region is situated in a region of an intermediate image plane.

2. Microscope according to claim 1,
wherein the beam shaping unit has refractive and/or diffractive optical units for beam redistribution or is formed by refractive and/or diffractive optical units for beam redistribution.

3. Microscope according to claim 1,
wherein the beam shaping unit is achromatic.

4. Microscope according to claim 1,
wherein the beam shaping unit has a structured optical fibre or is formed by a structured optical fibre.

5. Microscope according to claim 4,
wherein a refractive beam shaper is integrally formed at a fibre end of the optical fibre.

6. Microscope according to claim 1,
wherein adjustable component parts of the optical functional group are controllable, and
wherein the control unit is configured for controlling the adjustable component parts of the optical functional group.

7. Microscope according to claim 1,
wherein the optical functional group is configured for reproducing the flat-top region and for axially displacing the at least one flat-top region.

8. Microscope according to claim 1,
wherein the optical functional group has a zoom optical unit comprising at least one axially movable lens.

9. Microscope according to claim 1,
wherein the optical functional group has at least one spatial light modulator or is formed by a spatial light modulator.

10. Microscope according to claim 9,
wherein the control unit is configured to control the spatial light modulator for realizing a lens, the focal length of which is equal to a distance between the spatial light modulator and a closest downstream intermediate image plane.

11. Microscope according to claim 1,
wherein the optical functional group has a changer device comprising a first lens and a second lens or is realized by a changer device comprising a first lens and a second lens.

12. Microscope according to claim 1,
wherein the optical functional group has a lens with an adjustable focal length or is realized by a lens with an adjustable focal length.

13. Microscope according to claim 1,
wherein the optical functional group has a telescope optical unit providing a pupil plane or an intermediate image plane.

14. Microscope according to claim 1,
wherein the optical functional group has an optical module forming an alternative beam path comprising at least one lens, said alternative beam path having a pupil plane and an intermediate image plane,
wherein the illumination light either in a first setting state or in a second setting state is guided via the alternative beam path in the direction of the microscope objective.

15. Microscope according to claim 14,
wherein the optical module has a first switching device for guiding the illumination light via the alternative beam path of the illumination beam path, and
wherein the optical module has a second switching device for coupling the excitation light from the alternative beam path once again into a main part of the illumination beam path.

16. Microscope according to claim 14,
wherein the optically effective component parts of the optical module are rigidly connected to one another upon insertion of the optical module into the illumination beam path and upon removal of the optical module from the illumination beam path.

17. Microscope according to claim 1,
wherein the illumination beam path has a wavefront manipulator for compensating for quadratic phase components, said wavefront manipulator being arranged or formed in an intermediate image plane or in a vicinity of an intermediate image plane.

18. Microscope according to claim 1,
further comprising at least one first spatial light modulator, which is arranged in a pupil plane or in a vicinity of a pupil plane or in an intermediate image plane or in a vicinity of an intermediate image plane, and
wherein the control unit is configured to control the spatial light modulator for conditioning the illumination light for a respectively desired microscopy method.

19. Microscope according to claim 18,
wherein at least one of the spatial light modulators is a phase-modulating spatial light modulator.

20. Microscope according to claim 1,
wherein, for TIRF microscopy, an optical unit for generating a lateral beam offset for laterally displacing TIRF illumination spots in a back focal plane of the microscope objective is present in a pupil plane of the illumination beam path and/or
wherein a pivotable mirror for laterally displacing TIRF illumination spots in the back focal plane of the microscope objective is present in an intermediate image plane of the illumination beam path.

21. Microscope according to claim 1,
wherein, for SIM microscopy, a biaxially pivotable wobble plate is present or two, in each case uniaxially pivotable, wobble plates are present in a vicinity of an intermediate image plane of the illumination beam path.

22. Microscope according to claim 18,
wherein the control unit is configured to control the spatial light modulator in the pupil plane for generating a computer-generated hologram for illuminating the sample.

23. Method of microscopy for examining a sample, the method comprising:
guiding illumination light onto the sample via an illumination beam path comprising a microscope objective,
guiding emission light emitted by the sample owing to irradiation with the illumination light onto a detector via a detection beam path comprising the microscope objective or comprising a further microscope objective, and
a control unit evaluating measurement data of the detector,
wherein the illumination beam path has a beam shaping unit for providing at least one coherent flat-top region and an adjustable optical functional group, and
wherein the optical functional group, for conditioning the illumination beam path for a respectively desired microscopy mode, either is brought to a setting state in which the at least one flat-top region is situated in a region of a pupil plane, or is brought to a setting state in which the at least one flat-top region is situated in a region of an intermediate image plane.

24. Method according to claim 23,
wherein the optical functional group is set in such a way that the at least one flat-top region is situated in the region of the intermediate image plane, and
wherein a spatial light modulator arranged in the intermediate image plane is controlled for carrying out SIM or TIRF microscopy, or wherein the sample is examined using a widefield microscope method.

25. Method according to claim 23,
wherein the optical functional group is set in such a way that the at least one flat-top region is situated in the region of the pupil plane, and
wherein a spatial light modulator arranged in the pupil plane is controlled for generating a computer-generated hologram.

26. (canceled)
